(19) United States
(12) Patent Application Publication
(10) Pub. No.: US 2012/0286761 A1
(43) Pub. Date: Nov. 15, 2012

(54) WATERPROOF PH METER

(75) Inventor: Chen-Heng CHENG, Taichung City (TW)

(73) Assignee: AZ INSTRUMENT CORP., TAICHUNG CITY (TW)

(21) Appl. No.: 13/422,229

(22) Filed: Mar. 16, 2012

(30) Foreign Application Priority Data
May 12, 2011 (TW) 100144697

(51) Int. Cl. G01N 27/00

(52) U.S. Cl. 324/71.1

(57) ABSTRACT

A waterproof pH meter includes a main unit, a probe, which includes a probe electrode and a signal processing circuit, and a waterproof signal transmission line electrically coupled between a main circuit in the main unit and the signal processing circuit of the probe. When measuring a solution, a potential signal generated by the probe electrode is amplified by the signal processing circuit and then transmitted to the main unit through the waterproof signal transmission line for reading by the user. As the design has a better capacity in bearing noise interference, the signal transmission line can be selected from a regular waterproof cable instead of a BNC material.

### BACKGROUND OF THE INVENTION

1. Field of the Invention

The present invention relates to an instrument used for measuring the pH (acidity or alkalinity) of a liquid and more particularly, to a waterproof pH meter, which has the signal processing circuit embedded in the probe, so that the signal transmission line can be selected from a regular waterproof cable.

2. Description of the Related Art

A conventional pH meter generally includes a main unit, a probe and a signal transmission line. The probe has two electrodes arranged in the front end thereof. The main unit has a signal processing circuit arranged therein and electrically connected to the electrodes of the probe by the signal transmission line.

When the probe is dipped in the solution to be measured, hydrogen ions cause a potential difference between the two electrodes, and the potential signal thus produced is transmitted by the signal transmission line to the signal processing circuit for processing. The processed data is then displayed on a screen of the main unit for reading by the user.

However, the potential signal generated by the two electrodes may be interfered by external noises. To avoid this problem, the signal transmission line must be selected from a BNC (Bayonet Neil Concelman) material, and a BNC connector must be used for the connection between the signal transmission line and the main unit. However, a BNC connector is not waterproof. Thus, this design of pH meter is not wholly waterproof. An improvement in this regard is necessary.

### SUMMARY OF THE INVENTION

The present invention has been accomplished under the circumstances in view. It is the main object of the present invention to provide a waterproof pH meter, which has the signal processing circuit embedded in the probe so that the whole pH meter is waterproof.

To achieve this and other objects of the present invention, a waterproof pH meter comprises a main unit, a probe and a waterproof signal transmission line. The main unit comprises a user interface. The probe comprises a casing, a probe electrode mounted in one end of the casing, and a signal processing circuit mounted inside the casing and electrically coupled with the probe electrode. The signal processing circuit comprises an amplifier. The waterproof signal transmission line is electrically coupled between the main unit and the signal processing circuit of the probe.

Further, the main unit comprises a housing and a main circuit. The main circuit and the user interface are mounted in the housing. The main circuit is electrically coupled with the signal processing circuit of the probe through the waterproof signal transmission line.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating a waterproof pH meter embodying the present invention.

### DETAILED DESCRIPTION OF THE INVENTION

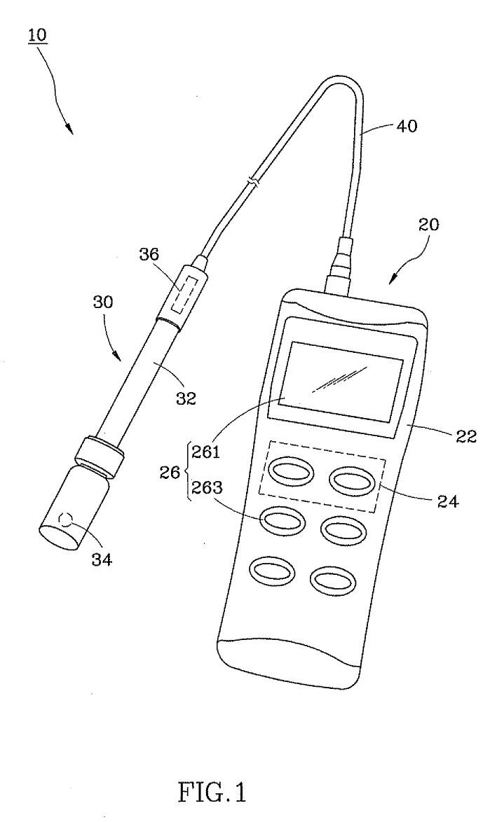

Referring to the annexed drawing of FIG. 1, a waterproof pH meter 10 in accordance with the present invention is shown. The waterproof pH meter 10 comprises a main unit 20, a probe 30, and a waterproof signal transmission line 40.

The main unit 20 comprises a housing 22, a main circuit 24, and a user interface 26. The main circuit 24 is a PCB (printed circuit board) accommodated inside the housing 22. The user interface 26 is arranged on the housing 22 and electrically coupled with the main circuit 24. The user interface 26 comprises a screen 261 for displaying the value measured by the waterproof pH meter 10, and a plurality of operating keys 263 operable by the user to control the waterproof pH meter 10.

The probe 30 comprises a casing 32, a probe electrode 34 and a signal processing circuit 36. The probe electrode 34 can be a silver chloride electrode, calomel electrode, or any other electrode sensitive to hydrogen ion concentration and capable of translating capable a hydrogen ion concentration into a potential signal. The probe electrode 34 is located on one end of the casing 32. The signal processing circuit 36 is a PCB (printed circuit board) accommodated inside the casing 32 and electrically coupled with the probe electrode 34. The signal processing circuit 36 comprises an amplifier for impedance conversion.

The waterproof signal transmission line 40 has two opposite ends thereof respectively affixed to the housing 22 of the main unit 20 and the casing 32 of the probe 30 and electrically connected to the main circuit 24 in the main unit 20 and the signal processing circuit 36 in the probe 30. The connection areas among the waterproof signal transmission line 40, the main unit 20 and the probe 30 are watertightly sealed.

When the probe 30 of the waterproof pH meter 10 is dipped in a solution, the signal processing circuit 36 amplifies the potential signal generated by the probe electrode 34 and then transmits the signal through the waterproof signal transmission line 40 to the main circuit 24 for processing into pH concentration data for display on the screen 261 for reading by the user.

As the signal processing circuit 36 is mounted inside the probe 30, the impedance converted from the measured signal of the probe electrode 34 by the signal processing circuit 36 can bear a relatively stronger signal interference. Thus, the waterproof signal transmission line 40 can be selected from a regular waterproof cable instead of a BNC material, achieving the desired waterproof effect.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A waterproof pH meter, comprising:
a main unit comprising a user interface;
a probe comprising a casing, a probe electrode mounted in one end of said casing, and a signal processing circuit mounted inside said casing and electrically coupled with said probe electrode, said signal processing circuit comprising an amplifier; and
a waterproof signal transmission line electrically coupled between said main unit and said signal processing circuit of said probe.

2. The waterproof pH meter as claimed in claim 1, wherein said main unit further comprises a housing and a main circuit, said main circuit and said user interface being mounted in said housing, said main circuit being electrically coupled with said signal processing circuit of said probe through said waterproof signal transmission line.
